(19) United States
(12) Patent Application Publication
(10) Pub. No.: US 2011/0033759 A1
(43) Pub. Date: Feb. 10, 2011

(54) METHOD FOR OPERATING A FUEL CELL

(75) Inventor: Thomas Schmidt, Morfelden-Walldorf (DE)

Correspondence Address: CONNOLLY BOVE LODGE & HUTZ, LLP, P O BOX 2207, WILMINGTON, DE, 19899, US

(73) Assignee: BASF SE, Lugwigshafen (DE)

(21) Appl. No.: 12/937,318

(22) PCT Filed: Apr. 8, 2009
(86) PCT No.: PCT/EP09/02585

§ 371 Date: Oct. 11, 2010

(30) Foreign Application Priority Data
Apr. 11, 2008 (EP) 08007168.1

(51) Int. Cl. H01M 8/04; H01M 8/06

(52) U.S. Cl. 429/425; 429/429

(57) ABSTRACT

The present invention relates to a method for operating a fuel cell, in particular for switching off a fuel cell. By means of the method according to the invention, a fuel cell may be stored in a better way, a defined low chemical potential being applied to both electrodes.

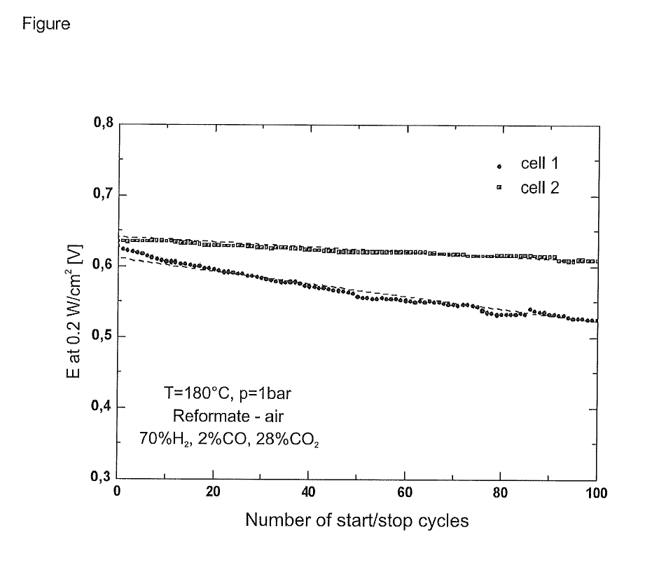

The present invention relates to a method for operating a fuel cell, in particular for switching off a fuel cell. By means of the method according to the invention, a fuel cell may be stored in a better way, a defined low chemical potential being applied to both electrodes.

Nowadays, sulphonic acid-modified polymers are almost exclusively used as proton-conducting membranes in polymer electrolyte membrane (PEM) fuel cells. Here, predominantly perfluorinated polymers are used. Nafion™ from DuPont de Nemours, Willmington, USA is a prominent example of this. For the conduction of protons, a relatively high water content is required in the membrane, which typically amounts to 4-20 molecules of water per sulphonic acid group. The required water content, but also the stability of the polymer in connection with acidic water and the reaction gases hydrogen and oxygen restrict the operating temperature of the PEM fuel cell stacks to 80-100° C. Higher operating temperatures cannot be implemented without a decrease in performance of the fuel cell. At temperatures higher than the dew point of water for a given pressure level, the membrane dries out completely and the fuel cell provides no more electric power as the resistance of the membrane increases to such high values that an appreciable current flow no longer occurs.

A membrane electrode assembly based on the technology set forth above is described, for example, in U.S. Pat. No. 5,464,700.

Due to system-specific reasons, however, operating temperatures in the fuel cell of more than 100° C. are desirable. The activity of the catalysts based on noble metals and contained in the membrane electrode assembly (MEA) is significantly improved at high operating temperatures.

Especially when the so-called reformates from hydrocarbons are used, the reformer gas contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, the cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system can be increased.

To achieve these temperatures, in general, membranes with new conductivity mechanisms are used. One approach to this end is the use of membranes which show ionic conductivity without employing water. The first promising development in this direction is set forth in the document WO96/13872.

Further high-temperature fuel cells are disclosed in JP-A-2001-196082 and DE 10235360 in which the sealing systems of the electrode membrane assembly are specifically examined.

The membrane electrode assemblies mentioned above are generally connected with planar bipolar plates which include channels for a flow of gas milled into the plates. As part of the membrane electrode assemblies has a higher thickness than the gaskets described before, a gasket is inserted between the gasket of the membrane electrode assemblies and the bipolar plates which is usually made of PTFE.

It has now been found that fuel cells that are not continuously operated or were frequently switched on and off show a reduced service life and performance, respectively. The observed loss in performance is only partially reversible, i.e. is only partially reversibly compensated in the subsequent operation such that the service life is reduced further.

It is an object of the present invention, inter alia, to prevent these losses in performance and to prevent the reduction in service life.

This and also further, not explicitly mentioned objects are achieved by means of the method according to claim 1.

Accordingly, an object of the present invention is a method for operating a fuel cell comprising
(i) a proton-conducting polymer electrolyte membrane or polymer electrolyte matrix,
(ii) at least one catalyst layer which is arranged on both sides of the proton-conducting polymer electrolyte membrane or polymer electrolyte matrix,
(iii) at least one electrically conductive gas diffusion layer which is arranged on both averted sides of the catalyst layer,
(iv) at least one bipolar plate which is arranged on both averted sides of the gas diffusion layer,
   comprising the following steps:
a) supplying a hydrogen-containing gas through the gas diffusion layer to the catalyst layer on the anode side by means of the gas ducts present in the bipolar plate,
b) supplying a gas mixture containing oxygen and nitrogen through the gas diffusion layer to the catalyst layer on the cathode side by means of the gas ducts present in the bipolar plate,
c) generating protons at the catalyst layer on the anode side,
d) diffusing the generated protons through the proton-conducting polymer electrolyte membrane or polymer electrolyte matrix,
e) reacting the protons with the oxygen-containing gas supplied from the cathode side,
f) tapping the formed voltage potential by means of the bipolar plate on the anode side and on the cathode side,
   characterized in that, to switch off the fuel cell, the supply of the gas mixture which contains oxygen and nitrogen is discontinued and the oxygen present at the cathode is reacted to exhaustion by means of reaction with the protons present and the residual oxygen content at the cathode side of the fuel cell is reduced to a concentration of 5% by volume and less, preferably 3% by volume and less, in particular 1% by volume and less.

### Proton-Conducting Polymer Electrolyte Membranes and Matrices

Polymer electrolyte membranes and polymer electrolyte matrices, respectively, suited for the purposes of the present invention are known per se.

In general, membranes are employed for this, which comprise acids, wherein the acids may be covalently bound to polymers. Furthermore, a flat material may be doped with an acid in order to form a suitable membrane.

These doped membranes can be produced, inter alia, by swelling flat materials, for example a polymer film, with a liquid comprising aciduous compounds, or by manufacturing a mixture of polymers and aciduous compounds and subsequently forming a membrane by forming a flat structure and subsequent solidification in order to form a membrane.

Polymers suitable for this purpose include, amongst others, polyolefins, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyhexafluoropropylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes;

polymers having C—O bonds in the backbone, for example polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethyleneterephthalate, polybutyleneterephthalate, polyhydroxybenzoate, polyhydroxypropionic acid, polypivalolacton, polycaprolacton, polymalonic acid, polycarbonate;

polymeric C—S-bonds in the backbone, for example polysulphide ether, polyphenylenesulphide, polysulphones, polyethersulphone;

polymeric C—N bonds in the backbone, for example polyimines, polyisocyanides, polyetherimine, polyetherimides, polyaniline, polyaramides, polyamides, polyhydrazides, polyurethanes, polyimides, polyazoles, polyazole ether ketone, polyazines;

liquid-crystalline polymers, in particular Vectra, and

inorganic polymers, for example polysilanes, polycarbosilanes, polysiloxanes, polysilicic acid, polysilicates, silicones, polyphosphazenes and polythiazyl.

Preferred herein are alkaline polymers, wherein this particularly applies to membranes doped with acids. Almost all known polymer membranes that are able to transport the protons come into consideration as alkaline polymer membranes doped with acid. Here, acids are preferred which are able to transport protons without additional water, for example by means of the so-called Grotthus mechanism.

As alkaline polymer within the context of the present invention, preferably an alkaline polymer with at least one nitrogen atom in a repeating unit is used.

According to a preferred embodiment, the repeating unit in the alkaline polymer contains an aromatic ring with at least one nitrogen atom. The aromatic ring is preferably a five-membered or six-membered ring with one to three nitrogen atoms which may be fused to another ring, in particular another aromatic ring.

According to one particular aspect of the present invention, polymers stable at high temperatures are used which contain at least one nitrogen, oxygen and/or sulphur atom in one or in different repeating units.

Within the context of the present invention, stable at high temperatures means a polymer which, as a polymeric electrolyte, can be operated over the long term in a fuel cell at temperatures above 120° C. Over the long term means that a membrane according to the invention can be operated for at least 100 hours, preferably at least 500 hours, at a temperature of at least 80° C., preferably at least 120° C., particularly preferably at least 160° C., without the performance being decreased by more than 50%, based on the initial performance, which can be measured according to the method described in WO 01/18894 A2. Furthermore, polymer electrolyte membranes stable at high temperatures or polymer electrolyte matrices stable at high temperatures are understood to mean those having a proton conductivity of at least 1 mS/cm, preferably at least 2 mS/cm, in particular at least 5 mS/cm, at temperatures of 120° C. Here, these values are achieved without moistening.

The abovementioned polymers can be used individually or as a mixture (blend). Here, preference is given in particular to blends which contain polyazoles and/or polysulphones. In this context, the preferred blend components are polyethersulphone, polyether ketone and polymers modified with sulphonic acid groups, as described in WO 02/36249. By using blends, the mechanical properties can be improved and the material costs can be reduced.

Polyazoles constitute a particularly preferred group of alkaline polymers. An alkaline polymer based on polyazole contains recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

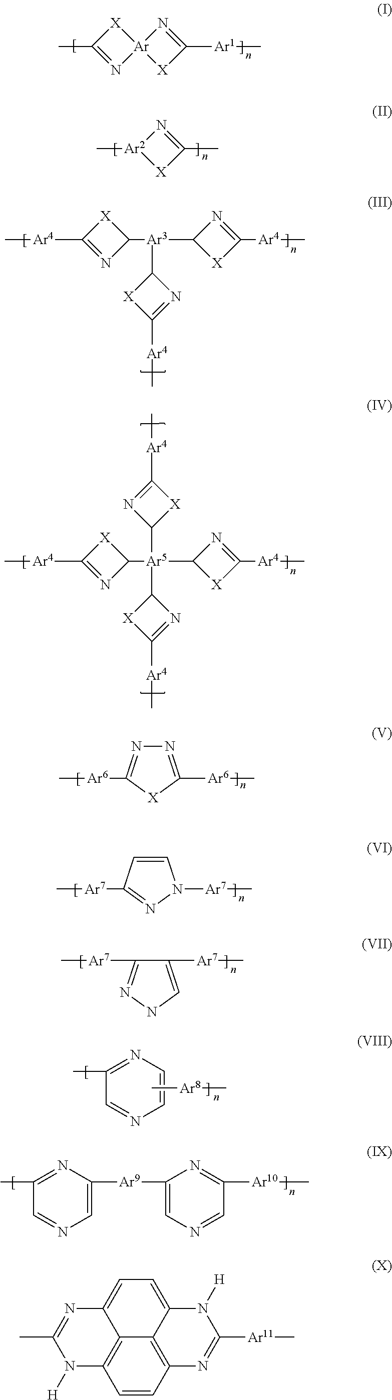

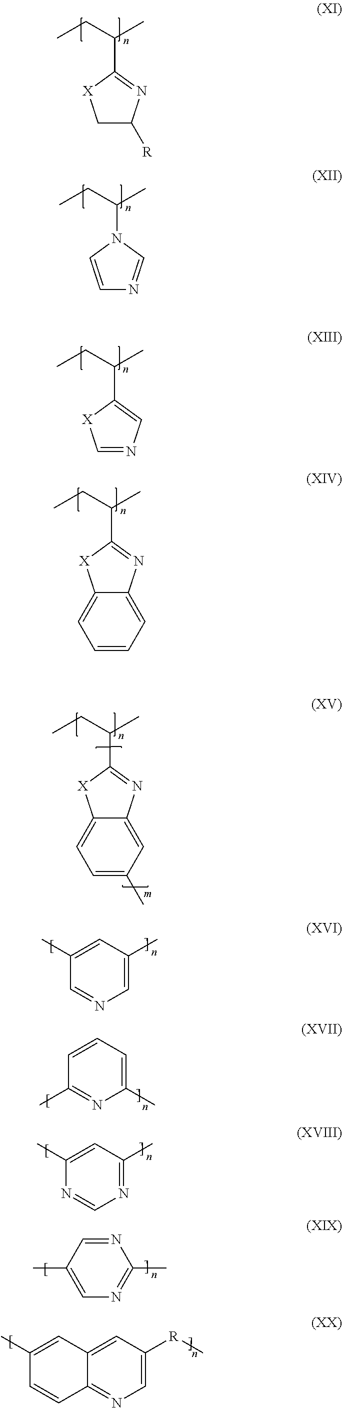

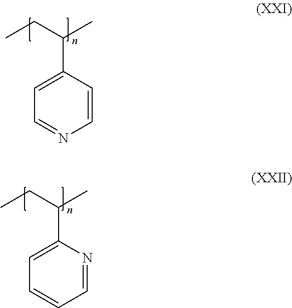

wherein
Ar are identical or different and represent a tetracovalent aromatic or heteroaromatic group which can be mononuclear or polynuclear,
Ar¹ are identical or different and represent a bicovalent aromatic or heteroaromatic group which can be mononuclear or polynuclear,
Ar² are identical or different and represent a bicovalent or tricovalent aromatic or heteroaromatic group which can be mononuclear or polynuclear,
Ar³ are identical or different and represent a tricovalent aromatic or heteroaromatic group which can be mononuclear or polynuclear,
Ar⁴ are identical or different and represent a tricovalent aromatic or heteroaromatic group which can be mononuclear or polynuclear,
Ar⁵ are identical or different and represent a tetracovalent aromatic or heteroaromatic group which can be mononuclear or polynuclear,
Ar⁶ are identical or different and represent a bicovalent aromatic or heteroaromatic group which can be mononuclear or polynuclear,
Ar⁷ are identical or different and represent a bicovalent aromatic or heteroaromatic group which can be mononuclear or polynuclear,
Ar⁸ are identical or different and represent a tricovalent aromatic or heteroaromatic group which can be mononuclear or polynuclear,
Ar⁹ are identical or different and represent a bicovalent or tricovalent or tetracovalent aromatic or heteroaromatic group which can be mononuclear or polynuclear,
Ar¹⁰ are identical or different and represent a bicovalent or tricovalent aromatic or heteroaromatic group which can be mononuclear or polynuclear,
Ar¹¹ are identical or different and represent a bicovalent aromatic or heteroaromatic group which can be mononuclear or polynuclear,
X are identical or different and represent oxygen, sulphur or an amino group which carries a hydrogen atom, a group having 1-20 carbon atoms, preferably a branched or unbranched alkyl or alkoxy group, or an aryl group as a further radical,
R are identical or different and represent hydrogen, an alkyl group and an aromatic group, with the proviso that R in formula (XX) is not hydrogen, and
   n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidines, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-phenylene, meta-phenylene and para-phenylene. Particularly preferred groups are derived from benzene and biphenylene which may also be substituted.

Preferred alkyl groups are short-chain alkyl groups having from 1 to 4 carbon atoms, such as, e.g., methyl, ethyl, n-propyl or i-propyl and t-butyl groups.

Preferred aromatic groups are phenyl or naphthyl groups. The alkyl groups and the aromatic groups may be substituted.

Preferred substituents are halogen atoms, such as, e.g., fluorine, amino groups, hydroxy groups or short-chain alkyl groups, such as, e.g., methyl or ethyl groups.

Preference is given to polyazoles having recurring units of the formula (I) in which the radicals X within a recurring unit are identical.

The polyazoles can in principle also have differing recurring units which, for example, differ in their radical X. However, there are preferably only identical radicals X in a recurring unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In a further embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole which only contains units of the formulae (I) and/or (II).

The number of recurring azole units in the polymer is preferably an integer greater than or equal to 10. Particularly preferred polymers contain at least 100 recurring azole units.

Within the context of the present invention, preference is given to polymers containing recurring benzimidazole units. Some examples of the most purposeful polymers containing recurring benzimidazole units are represented by the following formulae:

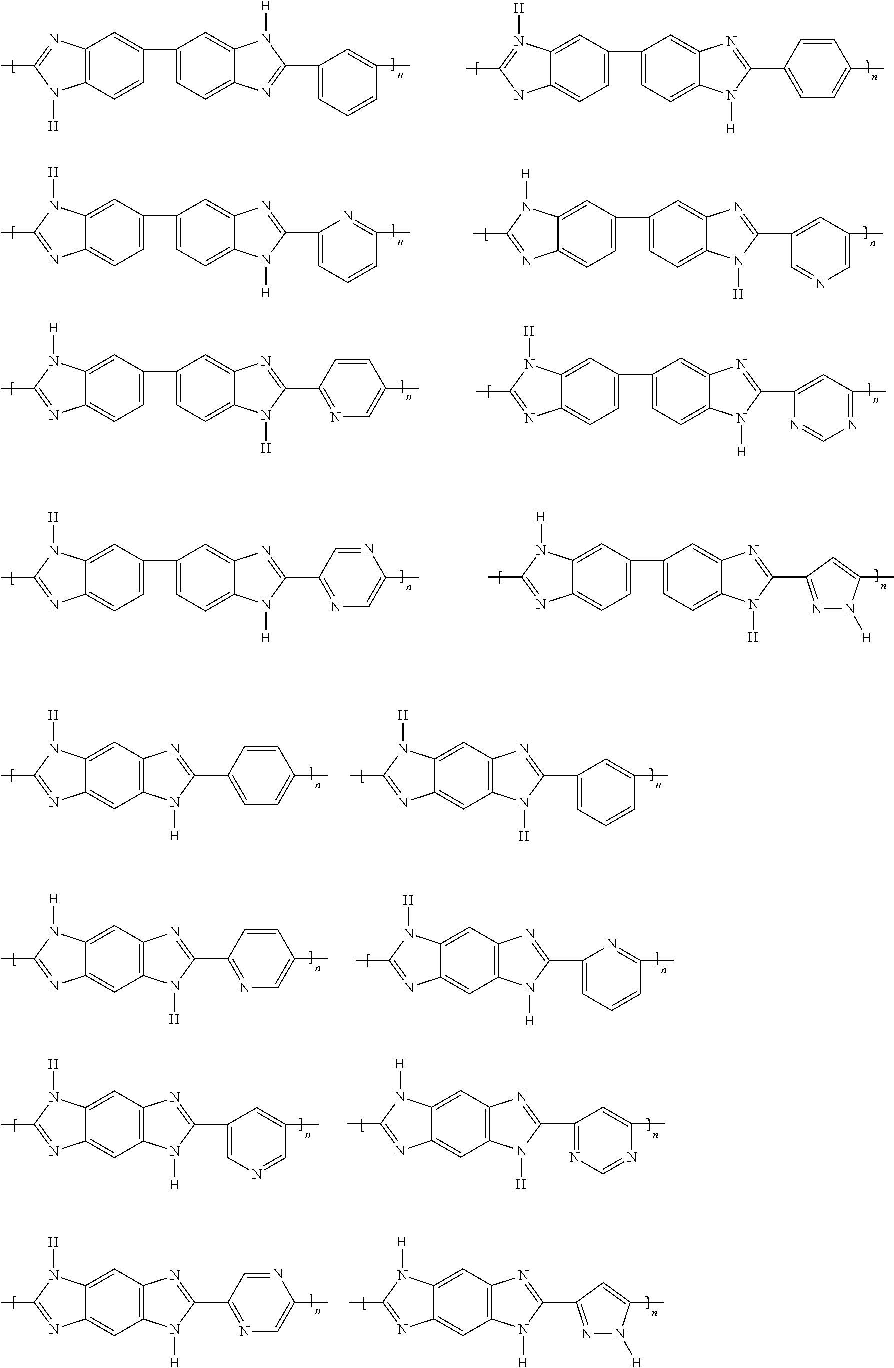

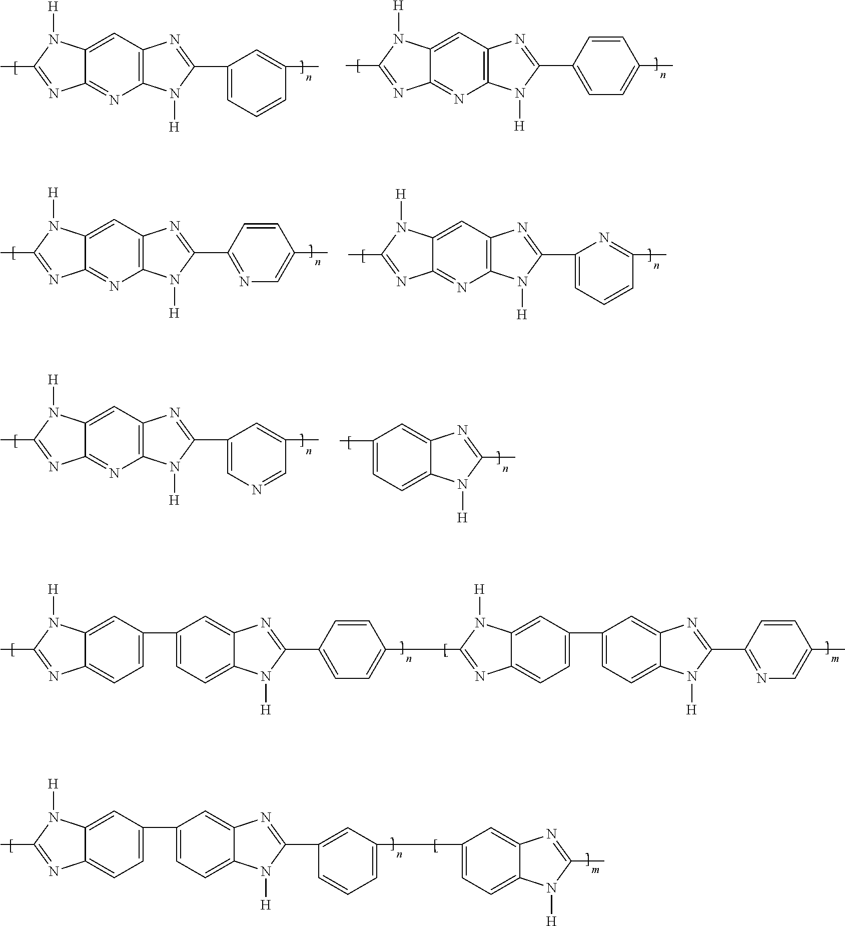

where n and m are each an integer greater than or equal to 10, preferably greater than or equal to 100.

The polyazoles used, in particular, however, the polybenzimidazoles are characterized by a high molecular weight. Measured as the intrinsic viscosity, this is preferably at least 0.2 dl/g, preferably 0.8 to 10 dl/g, in particular 1 to 10 dl/g.

The preparation of such polyazoles is known wherein one or more aromatic tetra-amino compounds are reacted in the melt with one or more aromatic carboxylic acids or the esters thereof, containing at least two acid groups per carboxylic acid monomer, to form a prepolymer. The resulting prepolymer solidifies in the reactor and is subsequently comminuted mechanically. The pulverulent prepolymer is usually finally polymerised in a solid-state polymerisation at temperatures of up to 400° C.

The preferred aromatic carboxylic acids are, amongst others, dicarboxylic and tricarboxylic acids and tetracarboxylic acids or their esters or their anhydrides or their acid chlorides. The term aromatic carboxylic acids likewise also comprises heteroaromatic carboxylic acids.

Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, 2,2-bis-(4-carboxyphenyl)hexafluoropropane, 4,4′-stilbenedicarboxylic acid, 4-carboxycinnamic acid or their C1-C20 alkyl esters or C5-C12 aryl esters or their acid anhydrides or their acid chlorides.

The aromatic tricarboxylic acids, tetracarboxylic acids or their C1-C20 alkyl esters or C5-C12 aryl esters or their acid anhydrides or their acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid or 3,5,4′-biphenyltricarboxylic acid.

The aromatic tetracarboxylic acids or their C1-C20 alkyl esters or C5-C12 aryl esters or their acid anhydrides or their acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids used are preferably heteroaromatic dicarboxylic acids, tricarboxylic acids and tetracarboxylic acids or their esters or their anhydrides. Heteroaromatic carboxylic acids are understood to mean aromatic systems which contain at least one nitrogen, oxygen, sulphur or phosphor atom in the aromatic group. Preferably, it is pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid and their C1-C20 alkyl esters or C5-C12 aryl esters or their acid anhydrides or their acid chlorides.

The content of tricarboxylic acids or tetracarboxylic acids (based on dicarboxylic acid used) is between 0 and 30 mol-%, preferably 0.1 and 20 mol-%, in particular 0.5 and 10 mol-%.

The aromatic and heteroaromatic diaminocarboxylic acids used are preferably diaminobenzoic acid and its monohydrochloride or dihydrochloride derivatives.

Preferably, mixtures of at least 2 different aromatic carboxylic acids are used. Particularly preferably, mixtures are used which also contain heteroaromatic carboxylic acids in addition to aromatic carboxylic acids. The mixing ratio of aromatic carboxylic acids to heteroaromatic carboxylic acids is between 1:99 and 99:1, preferably 1:50 to 50:1.

These mixtures are in particular mixtures of N-heteroaromatic dicarboxylic acids and aromatic dicarboxylic acids. Non-limiting examples of these are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The preferred aromatic tetramino compounds include, amongst others, 3,3′,4,4′-tetraminobiphenyl, 2,3,5,6-tetraminopyridine, 1,2,4,5-tetraminobenzene, 3,3′,4,4′-tetraminodiphenyl sulphone, 3,3′,4,4′-tetraminodiphenyl ether, 3,3′,4,4′-tetraminobenzophenone, 3,3′,4,4′-tetraminodiphenylmethane and 3,3′,4,4′-tetraminodiphenyldimethylmethane as well as their salts, in particular their monohydrochloride, dihydrochloride, trihydrochloride and tetrahydrochloride derivatives.

Preferred polybenzimidazoles are commercially available under the trade name ® Celazole.

Preferred polymers include polysulphones, in particular polysulphone having aromatic and/or heteroaromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. Here, preference is given to polysulphones with a Vicat softening temperature VST/A/50 of 180° C. to 230° C. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F and/or G.

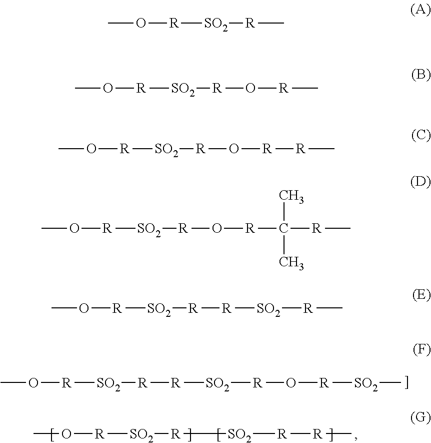

wherein the radicals R, independently of another, identical or different, represent aromatic or heteroaromatic groups, these radicals having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the scope of the present invention include homopolymers and copolymers, for example random copolymers. Particularly preferred polysulphones comprise recurring units of the formulae H to N:

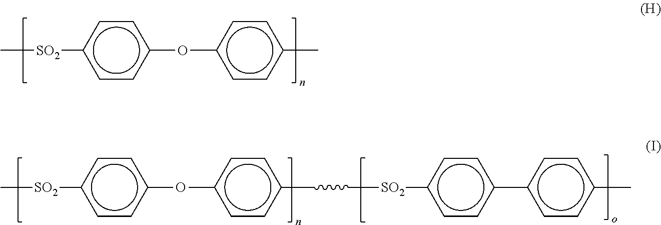

where n>o

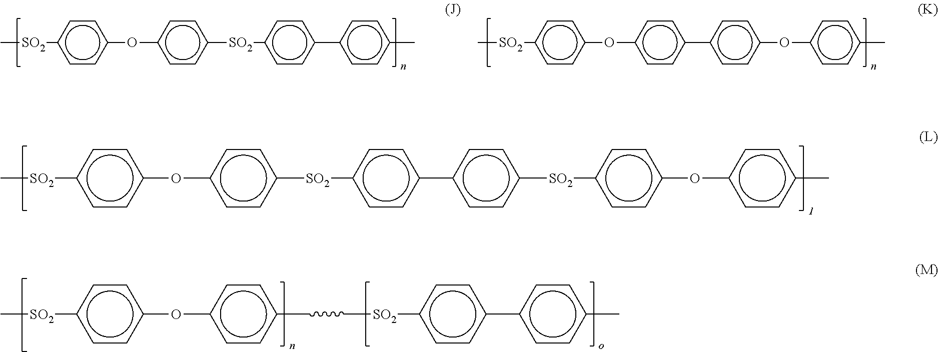

where n<o

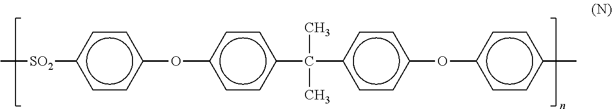

The previously described polysulphones can be obtained commercially under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

The polysulphones mentioned above and the polyether ketones, polyether ketone ketones, polyether ether ketones, polyether ether ketone ketones and polyaryl ketones mentioned can be, as already set forth, present as a blend component with alkaline polymers. Furthermore, the polysulphones mentioned above and the polyether ketones, polyether ketone ketones, polyether ether ketones, polyether ether ketone ketones and polyaryl ketones mentioned above can be used in sulphonated form as a polymer electrolyte wherein the sulphonated materials can also feature alkaline polymers, in particular polyazoles as a blend material. The embodiments shown and preferred with regard to the alkaline polymers or polyazoles also apply to these embodiments.

To produce polymer films, a polymer, preferably an alkaline polymer, in particular a polyazole can be dissolved in an additional step in polar, aprotic solvents such as dimethylacetamide (DMAc) and a film can be produced by means of classical methods.

In order to remove residues of solvents, the film thus obtained can be treated with a washing liquid, as is described in WO 02/071518. Due to the cleaning of the polyazole film to remove residues of solvent described in the German patent application, the mechanical properties of the film are surprisingly improved. These properties include in particular the E-modulus, the tear strength and the break strength of the film.

Additionally, the polymer film can have further modifications, for example by cross-linking, as described in WO 02/070592 or in WO 00/44816. In a preferred embodiment, the polymer film used consisting of an alkaline polymer and at least one blend component additionally contains a cross-linking agent, as described in WO 03/016384.

The thickness of the polyazole films can be within wide ranges. Preferably, the thickness of the polyazole film before its doping with acid is generally in the range of 5 μm to 2000 μm, particularly preferably in the range of 10 μm to 1000 μm; however, this should not constitute a limitation.

In order to achieve proton conductivity, these films are doped with an acid. In this context, acids include all known Lewis und Brønsted acids, preferably inorganic Lewis und Brønsted acids.

Furthermore, the application of polyacids is also possible, in particular isopolyacids and heteropolyacids as well as mixtures of different acids. Here, in the spirit of the invention, heteropolyacids define inorganic polyacids with at least two different central atoms, each formed of weak, polybasic oxygen acids of a metal (preferably Cr, MO, V, W) and a non-metal (preferably As, I, P, Se, Si, Te) as partial mixed anhydrides. These include, amongst others, the 12-phosphomolybdic acid and the 12-phosphotungstic acid.

The degree of doping can influence the conductivity of the polyazole film. The conductivity increases with an increasing concentration of the doping substance until a maximum value is reached. According to the invention, the degree of doping is given as mole of acid per mole of repeating unit of the polymer. Within the scope of the present invention, a degree of doping between 3 and 50, in particular between 5 and 40 is preferred.

Particularly preferred doping substances are sulphuric acid and phosphoric acid or compounds releasing these acids, for example during hydrolysis or depending on temperature. A very particularly preferred doping substance is phosphoric acid (H₃PO₄). Here, highly concentrated acids are generally used. According to a particular aspect of the present invention, the concentration of the phosphoric acid is at least 50% by weight, in particular at least 80% by weight, based on the weight of the doping substance.

Furthermore, proton-conductive membranes can be obtained by a method comprising the steps:
I) dissolving of polymers, particularly polyazoles in phosphoric acid,
II) heating the solution obtainable in accordance with step I) under inert gas to temperatures of up to 400° C.,
III) forming a membrane using the solution of the polymer in accordance with step II) on a support and
IV) treating the membrane formed in step III) until it is self-supporting.

Furthermore, doped polyazole films can be obtained by a method comprising the steps of
A) mixing one or more aromatic tetramino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion,
B) applying a layer using the mixture in accordance with step A) to a support or to an electrode,
C) heating the flat structure/layer obtainable in accordance with step B) under inert gas to temperatures of up to 350° C., preferably up to 280° C., with formation of the polyazole polymer,
D) treating the membrane formed in step C) (until it is self-supporting).

The aromatic or heteroaromatic carboxylic acid and tetramino compounds to be employed in step A) have been described above.

The polyphosphoric acid used in step A) is a customary polyphosphoric acid as is available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The mixture produced in step A) has a weight ratio of polyphosphoric acid to the sum of all monomers of from 1:10,000 to 10,000:1, preferably 1:1000 to 1000:1, in particular 1:100 to 100:1.

The layer formation in accordance with step B) is performed by means of measures known per se (pouring, spraying, application with a doctor blade) which are known from the prior art of polymer film production. Every support that is considered as inert under the conditions is suitable as a support. To adjust the viscosity, phosphoric acid (conc. phosphoric acid, 85%) can be added to the solution, where required. Thus, the viscosity can be adjusted to the desired value and the formation of the membrane be facilitated.

The layer produced in accordance with step B) has a thickness of 20 to 4000 μm, preferably of 30 to 3500 μm, in particular of 50 to 3000 μm.

If the mixture in accordance with step A) also contains tricarboxylic acids or tetracarboxylic acid, branching/cross-linking of the formed polymer is achieved therewith. This contributes to an improvement in the mechanical property. The treatment of the polymer layer produced in accordance with step C) is performed in the presence of moisture at temperatures and for a sufficient period of time until the layer exhibits a sufficient strength for use in fuel cells. The treatment can be effected to the extent that the membrane is self-supporting so that it can be detached from the support without any damage.

In accordance with step C), the flat structure obtained in step B) is heated to a temperature of up to 350° C., preferably up to 280° C. and particularly preferably in the range of 200° C. to 250° C. The inert gases to be used in step C) are known to those in professional circles. These include in particular nitrogen as well as noble gases, such as neon, argon, helium.

In a variant of the method, the formation of oligomers and/or polymers can already be brought about by heating the mixture from step A) to temperatures of up to 350° C., preferably up to 280° C. Depending on the selected temperature and duration, it is subsequently possible to dispense partly or fully with the heating in step C). This variant is also an object of the present invention.

The treatment of the membrane in step D) is performed at temperatures above 0° C. and below 150° C., preferably at temperatures between 10° C. and 120° C., in particular between room temperature (20° C.) and 90° C., in the presence of moisture or water and/or steam and/or water-containing phosphoric acid of up to 85%. The treatment is preferably performed at normal pressure, but can also be carried out with action of pressure. It is essential that the treatment takes place in the presence of sufficient moisture whereby the polyphosphoric acid present contributes to the solidification of the membrane by means of partial hydrolysis with formation of low molecular weight polyphosphoric acid and/or phosphoric acid.

The hydrolysis fluid may be a solution wherein the fluid may also contain suspended and/or dispersed constituents. The viscosity of the hydrolysis fluid can be within wide ranges wherein an addition of solvents or an increase in temperature can take place to adjust the viscosity. The dynamic viscosity is preferably in the range of 0.1 to 10,000 mPa*s, in particular 0.2 to 2000 mPa*s, wherein these values can be measured in accordance with DIN 53015, for example.

The treatment in accordance with step D) can take place with any known method. The membrane obtained in step C) can, for example, be immersed in a fluid bath. Furthermore, the hydrolysis fluid can be sprayed onto the membrane. Additionally, the hydrolysis fluid can be poured onto the membrane. The latter methods have the advantage that the concentration of the acid in the hydrolysis fluid remains constant during the hydrolysis. However, the first method is often cheaper in practice.

The oxo acids of phosphorus and/or sulphur include in particular phosphinic acid, phosphonic acid, phosphoric acid, hypodiphosphonic acid, hypodiphosphoric acid, oligophosphoric acids, sulphurous acid, disulphurous acid and/or sulphuric acid. These acids can be used individually or as a mixture.

Furthermore, the oxo acids of phosphorus and/or sulphur comprise monomers that can be processed by free-radical polymerisation and comprise phosphonic acid and/or sulphonic acid groups.

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising phosphonic acid groups results from the polymerisation product which is obtained by polymerising the monomer comprising phosphonic acid groups alone or with other monomers and/or cross-linking agents.

The monomer comprising phosphonic acid groups may comprise one, two, three or more carbon-carbon double bonds. Furthermore, the monomer comprising phosphonic acid groups may contain one, two, three or more phosphonic acid groups.

In general, the monomer comprising phosphonic acid groups contains 2 to 20, preferably 2 to 10 carbon atoms.

The monomer comprising phosphonic acid groups is preferably a compound of the formula

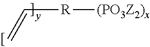

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, —CN, and
x represents an integer 1, 2, 3, 4, 5, 6, 7, 8, 9 or 10,
y represents an integer 1, 2, 3, 4, 5, 6, 7, 8, 9 or 10,
   and/or of the formula

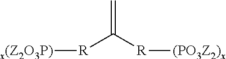

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, —CN, and
x represents an integer 1, 2, 3, 4, 5, 6, 7, 8, 9 or 10,
   and/or of the formula

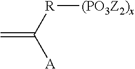

wherein
A represents a group of the formulae COOR², CN, CONR²₂, OR² and/or R², wherein R² is hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, —CN, and
x represents an integer 1, 2, 3, 4, 5, 6, 7, 8, 9 or 10.

Preferred monomers comprising phosphonic acid groups include, inter alia, alkenes which contain phosphonic acid groups, such as ethenephosphonic acid, propenephosphonic acid, butenephosphonic acid; acrylic acid compounds and/or methacrylic acid compounds which contain phosphonic acid groups, such as for example 2-phosphonomethylacrylic acid, 2-phosphonomethylmethacrylic acid, 2-phosphonomethylacrylamide and 2-phosphonomethylmethacrylamide.

Commercially available vinylphosphonic acid (ethenephosphonic acid), such as it is available from the company Aldrich or Clariant GmbH, for example, is particularly preferably used. A preferred vinylphosphonic acid has a purity of more than 70%, in particular 90% and particularly preferably a purity of more than 97%.

The monomers comprising phosphonic acid groups can furthermore be employed in the form of derivatives, which subsequently can be converted to the acid, wherein the conversion to the acid can also take place in the polymerised state. These derivatives include in particular the salts, the esters, the amides and the halides of the monomers comprising phosphonic acid groups.

Furthermore, the monomers comprising phosphonic acid groups can also be introduced onto and into the membrane after the hydrolysis. This can be performed by means of measures known per se (e.g., spraying, immersing etc.) which are known from the prior art.

According to a particular aspect of the present invention, the ratio of the weight of the sum of phosphoric acid, polyphosphoric acid and the hydrolysis products of the polyphosphoric acid to the weight of the monomers that can be processed by free-radical polymerisation, for example the monomers comprising phosphonic acid groups, is preferably greater than or equal to 1:2, in particular greater than or equal to 1:1 and particularly preferably greater than or equal to 2:1.

Preferably, the ratio of the weight of the sum of phosphoric acid, polyphosphoric acid and the hydrolysis products of the polyphosphoric acid to the weight of the monomers that can be processed by free-radical polymerisation is in the range of from 1000:1 to 3:1, in particular 100:1 to 5:1 and particularly preferably 50:1 to 10:1.

This ratio can easily be determined by means of customary methods in which, in many cases, the phosphoric acid, polyphosphoric acid and their hydrolysis products can be washed out of the membrane. Through this, the weight of the polyphosphoric acid and its hydrolysis products can be obtained after the completed hydrolysis to phosphoric acid. In general, this also applies to the monomers which can be processed by free-radical polymerisation.

Monomers comprising sulphonic acid groups are known in professional circles. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising sulphonic acid groups results from the polymerisation product which is obtained by polymerisation of the monomer comprising sulphonic acid groups alone or with further monomers and/or cross-linking agents.

The monomer comprising sulphonic acid groups may comprise one, two, three or more carbon-carbon double bonds. Furthermore, the monomer comprising sulphonic acid groups can contain one, two, three or more sulphonic acid groups.

Generally, the monomer comprising sulphonic acid groups contains 2 to 20, preferably 2 to 10, carbon atoms.

The monomer comprising sulphonic acid groups is preferably a compound of the formula

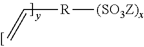

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, —CN, and
x represents an integer 1, 2, 3, 4, 5, 6, 7, 8, 9 or 10,
y represents an integer 1, 2, 3, 4, 5, 6, 7, 8, 9 or 10,
   and/or of the formula

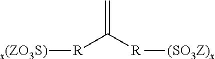

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, —CN, and
x represents an integer 1, 2, 3, 4, 5, 6, 7, 8, 9 or 10,
   and/or of the formula

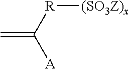

wherein
A represents a group of the formulae COOR², CN, CONR²₂, OR² and/or R², wherein R² is hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned radicals themselves can be substituted with halogen, —OH, —CN, and
x represents an integer 1, 2, 3, 4, 5, 6, 7, 8, 9 or 10.

Preferred monomers comprising sulphonic acid groups include, inter alia, alkenes which contain sulphonic acid groups, such as ethenesulphonic acid, propenesulphonic acid, butenesulphonic acid; acrylic acid compounds and/or methacrylic acid compounds which contain sulphonic acid groups, such as for example 2-sulphonomethylacrylic acid, 2-sulphonomethylmethacrylic acid, 2-sulphonomethylacrylamide and 2-sulphonomethylmethacrylamide.

Commercially available vinylsulphonic acid (ethenesulphonic acid), such as it is available from the company Aldrich or Clariant GmbH, for example, is particularly preferably used. A preferred vinylsulphonic acid has a purity of more than 70%, in particular 90% and particularly preferably a purity of more than 97%.

The monomers comprising sulphonic acid groups can furthermore be used in the form of derivatives which can subsequently be converted to the acid, wherein the conversion to the acid may also take place in the polymerised state. These derivatives include in particular the salts, the esters, the amides and the halides of the monomers comprising sulphonic acid groups.

Furthermore, the monomers comprising sulphonic acid groups can also be introduced onto and into the membrane after the hydrolysis. This can be performed by means of measures known per se (e.g., spraying, immersing etc.) which are known from the prior art.

In another embodiment of the invention, monomers capable of cross-linking can be used. These monomers can be added to the hydrolysis fluid. Furthermore, the monomers capable of cross-linking can also be applied to the membrane obtained after the hydrolysis.

The monomers capable of cross-linking are in particular compounds having at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

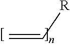

dimethylacrylates, trimethylacrylates, tetramethylacrylates of the formula

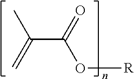

diacrylates, triacrylates, tetraacrylates of the formula

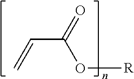

wherein
R represents a C1-C15 alkyl group, a C5-C20 aryl or heteroaryl group, NR′, —SO₂, PR′, Si(R′)₂, wherein the above-mentioned radicals themselves can be substituted,
R′ represent, independently of another, hydrogen, a C1-C15 alkyl group, a C1-C15 alkoxy group, a C5-C20 aryl or heteroaryl group, and
n is at least 2.

The substituents of the above-mentioned radical R are preferably halogen, hydroxyl, carboxy, carboxyl, carboxylester, nitriles, amines, silyl, siloxane radicals.

Particularly preferred cross-linking agents are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol A dimethylacrylate. These compounds are commercially available from Sartomer Company Exton, Pa. under the designations CN-120, CN104 and CN-980, for example.

The use of cross-linking agents is optional, wherein these compounds can typically be employed in the range of 0.05 and 30% by weight, preferably 0.1 to 20% by weight, particularly preferably 1 to 10% by weight, based on the weight of the membrane.

The cross-linking monomers can be introduced onto and into the membrane after the hydrolysis. This can be performed by means of measures known per se (e.g., spraying, immersing etc.) which are known from the prior art.

According to a particular aspect of the present invention, the monomers comprising phosphonic acid and/or sulphonic acid groups or the cross-linking monomers can be polymerised wherein the polymerisation is preferably a free-radical polymerisation. The formation of radicals can take place thermally, photochemically, chemically and/or electrochemically.

For example, a starter solution containing at least one substance capable of forming radicals can be added to the hydrolysis fluid. Furthermore, the starter solution can be applied to the membrane after the hydrolysis. This can be performed by means of measures known per se (e.g., spraying, immersing etc.) which are known from the prior art.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl)peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert-butylper-2-ethyl hexanoate, ketone peroxide, methyl isobutyl ketone peroxide, cyclohexanone peroxide, dibenzoyl peroxide, tert-butylperoxybenzoate, tert-butylperoxyisopropylcarbonate, 2,5-bis(2-ethylhexanoylperoxy)-2,5-dimethylhexane, tert-butylperoxy-2-ethylhexanoate, tert.-butylperoxy-3,5,5-trimethylhexanoate, tert-butylperoxyisobutyrate, tert-butylperoxyacetate, dicumene peroxide, 1,1-bis(tert-butylperoxy)cyclohexane, 1,1-bis(tert-butylperoxy)-3,3,5-trimethylcyclohexane, cumyl hydroperoxide, tert-butylhydroperoxide, bis(4-tert-butylcyclohexyl)peroxydicarbonate, and the radical formers available from DuPont under the name ®Vazo, for example ®Vazo V50 and ®Vazo WS.

Furthermore, use may also be made of radical formers which form free radicals when exposed to radiation. Preferred compounds include, amongst others, diethoxyacetophenone (DEAP, Upjon Corp), n-butyl benzoin ether ®Trigonal-14, AKZO) and 2,2-dimethoxy-2-phenylacetophenone (®Igacure 651) and 1-benzoyl cyclohexanol ®Igacure 184), bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959), each of which are commercially available from the company Ciba Geigy Corp.

Typically, between 0.0001 and 5% by weight, in particular 0.01 to 3% by weight (based on the weight of the monomers that can be processed by free-radical polymerisation; monomers comprising phosphonic acid groups and/or sulphonic acid groups or the cross-linking monomers, respectively) of radical formers are added. The amount of radical formers can be varied according to the degree of polymerisation desired.

The polymerisation can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N. C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerisation may also take place by exposure to β rays, γ rays and/or electron rays. According to a particular embodiment of the present invention, a membrane is irradiated with a radiation dose in the range of 1 to 300 kGy, preferably 3 to 200 kGy and very particularly preferably 20 to 100 kGy.

The polymerisation of the monomers comprising phosphonic acid and/or sulphonic acid groups or the cross-linking monomers, respectively, preferably takes place at temperatures of more than room temperature (20° C.) and less than 200° C., in particular at temperatures between 40° C. and 150° C., particularly preferably between 50° C. and 120° C. The polymerisation is preferably performed at normal pressure, but can also be carried out with action of pressure. The polymerisation leads to a solidification of the flat structure, wherein this solidification can be observed via measuring the microhardness. Preferably, the increase in hardness caused by the polymerisation is at least 20%, based on the hardness of a correspondingly hydrolysed membrane without polymerisation of the monomers.

According to a particular aspect of the present invention, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups is preferably greater than or equal to 1:2, in particular greater than or equal to 1:1 and particularly preferably greater than or equal to 2:1.

Preferably, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups lies in the range of 1000:1 to 3:1, in particular 100:1 to 5:1 and particularly preferably 50:1 to 10:1.

The molar ratio can be determined by means of customary methods. To this end, especially spectroscopic methods, for example, NMR spectroscopy, can be employed. In this connection, it has to be considered that the phosphonic acid groups are present in the formal oxidation stage 3 and the phosphorus in phosphoric acid, polyphosphoric acid or hydrolysis products thereof, respectively, in oxidation stage 5.

Depending on the degree of polymerisation desired, the flat structure which is obtained after polymerisation is a self-supporting membrane. Preferably, the degree of polymerisation is at least 2, in particular at least 5, particularly preferably at least 30 repeating units, in particular at least 50 repeating units, very particularly preferably at least 100 repeating units. This degree of polymerisation is determined via the number-average molecular weight Mₙ which can be determined by means of GPC methods. Due to the problems of isolating the polymers comprising phosphonic acid groups contained in the membrane without degradation, this value is determined by means of a sample which is obtained by polymerisation of monomers comprising phosphonic acid groups without addition of polymer. In this connection, the weight proportion of monomers comprising phosphonic acid groups and of radical starters in comparison to the ratios of the production of the membrane is kept constant. The conversion achieved in a comparative polymerisation is preferably greater than or equal to 20%, in particular greater than or equal to 40% and particularly preferably greater than or equal to 75%, based on the monomers comprising phosphonic acid groups used.

The hydrolysis fluid comprises water wherein the concentration of the water generally is not particularly critical. According to a particular aspect of the present invention, the hydrolysis fluid comprises 5 to 80% by weight, preferably 8 to 70% by weight and particularly preferably 10 to 50% by weight, of water. The amount of water which is formally included in the oxo acids is not taken into account in the water content of the hydrolysis fluid.

Of the above-mentioned acids, phosphoric acid and/or sulphuric acid are particularly preferred, wherein these acids comprise in particular 5 to 70% by weight, preferably 10 to 60% by weight and particularly preferably 15 to 50% by weight, of water.

The partial hydrolysis of the polyphosphoric acid in step D) leads to a solidification of the membrane due to a sol-gel transition. This is also connected with a reduction in the layer thickness to 15 to 3000 μm, preferably between 20 and 2000 μm, in particular between 20 and 1500 μm; the membrane is self-supporting. The intramolecular and intermolecular structures (interpenetrating networks IPN) present in the polyphosphoric acid layer in accordance with step B) lead to an ordered membrane formation in step C), which is responsible for the particular properties of the membrane formed.

The upper temperature limit for the treatment in accordance with step D) is typically 150° C. With extremely short action of moisture, for example from overheated steam, this steam can also be hotter than 150° C. The duration of the treatment is substantial for the upper limit of the temperature.

The partial hydrolysis (step D) can also take place in climatic chambers where the hydrolysis can be specifically controlled with defined moisture action. In this connection, the moisture can be specifically set via the temperature or saturation of the surrounding area in contact with it, for example gases such as air, nitrogen, carbon dioxide or other suitable gases, or steam. The duration of the treatment depends on the parameters chosen as aforesaid.

Furthermore, the duration of the treatment depends on the membrane thicknesses.

Typically, the duration of the treatment amounts to between a few seconds to minutes, for example with the action of overheated steam, or up to whole days, for example in the open air at room temperature and low relative humidity. Preferably, the duration of the treatment is between 10 seconds and 300 hours, in particular 1 minute to 200 hours.

If the partial hydrolysis is performed at room temperature (20° C.) with ambient air having a relative humidity of 40-80%, the duration of the treatment is between 1 and 200 hours.

The membrane obtained in accordance with step D) can be formed in such a way that it is self-supporting, i.e. it can be detached from the support without any damage and then directly processed further, if applicable.

The concentration of phosphoric acid and therefore the conductivity of the polymer membrane can be set via the degree of hydrolysis, i.e. the duration, temperature and ambient humidity. The concentration of the phosphoric acid is given as mole of acid per mole of repeating unit of the polymer. Membranes with a particularly high concentration of phosphoric acid can be obtained by the method comprising the steps A) to D). A concentration of 10 to 50 (mole of phosphoric acid, based on one repeating unit of formula (I), for example polybenzimidazole), particularly between 12 and 40 is preferred. Only with very much difficulty or not at all is it possible to obtain such high degrees of doping (concentrations) by doping polyazoles with commercially available orthophosphoric acid.

In a variant of the method according to the invention, the preparation of the doped polyazole films can also be effected by means of a method comprising the steps of
1) reacting one or more aromatic tetramino compounds with one or more aromatic carboxylic acids or their esters, which contain at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in accordance with step 1) in polyphosphoric acid,
3) heating the solution obtainable in accordance with step 2) under inert gas to temperatures of up to 300° C., preferably up to 280° C., with formation of the dissolved polyazole polymer,
4) forming a membrane using the solution of the polyazole polymer in accordance with step 3) on a support and
5) treating the membrane formed in step 4) until it is self-supporting.

The steps of the method set forth under items 1) to 5) have been explained before in detail for the steps A) to D), where reference is made thereto, in particular with regard to preferred embodiments.

A membrane, particularly a membrane based on polyazoles, can further be cross-linked at the surface by action of heat in the presence of atmospheric oxygen. This hardening of the membrane surface further improves the properties of the membrane. To this end, the membrane can be heated to a temperature of at least 150° C., preferably at least 200° C. and particularly preferably at least 250° C. In this step of the method, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of from about 700 to 2000 nm and an energy in the range of from about 0.6 to 1.75 eV), respectively. Another method is β-ray irradiation. In this connection, the irradiation dose is from 5 to 200 kGy.

Depending on the desired degree of crosslinking, the duration of the crosslinking reaction may lie within a wide range. In general, this reaction time lies in the range of 1 second to 10 hours, preferably 1 minute to 1 hour; however, this should not constitute a limitation.

Particularly preferred polymer membranes display a high performance. The reason for this is in particular an improved proton conductivity. This is at least 1 mS/cm, preferably at least 2 mS/cm, in particular at least 5 mS/cm at temperatures of 120° C. Here, these values are achieved without moistening.

The specific conductivity is measured by means of impedance spectroscopy in a 4-pole arrangement in potentiostatic mode and using platinum electrodes (wire, 0.25 mm diameter). The gap between the current-collecting electrodes is 2 cm. The spectrum obtained is evaluated using a simple model consisting of a parallel arrangement of an ohmic resistance and a capacitor. The cross-section of the sample of the membrane doped with phosphoric acid is measured immediately prior to mounting of the sample. To measure the temperature dependency, the measurement cell is brought to the desired temperature in an oven and regulated using a Pt-100 thermocouple arranged in the immediate vicinity of the sample. Once the temperature is reached, the sample is held at this temperature for 10 minutes prior to the start of measurement.

### Gas Diffusion Layer

The membrane electrode assembly according to the invention has two gas diffusion layers which are separated by the polymer electrolyte membrane. Flat, electrically conductive and acid-resistant structures are commonly used for this. These include, for example, graphite-fibre paper, carbon-fibre paper, graphite fabric and/or paper which was rendered conductive by addition of carbon black. Through these layers, a fine distribution of the flows of gas and/or liquid is achieved. Suitable materials are generally known in professional circles.

Generally, this layer has a thickness in the range of from 80 μm to 2000 μm, in particular 100 μm to 1000 μm and particularly preferably 150 μm to 500 μm.

According to a particular embodiment, at least one of the gas diffusion layers can be comprised of a compressible material. Within the scope of the present invention, a compressible material is characterized by the characteristic that the gas diffusion layer can be compressed by pressure to half, in particular a third of its original thickness without losing its integrity.

This property is generally exhibited by a gas diffusion layer made of graphite fabric and/or graphite paper which was rendered conductive by addition of carbon black. The gas diffusion layers are usually also optimised in respect of their hydrophobicity and mass transfer properties by the addition of further materials. In this connection, the gas diffusion layers are equipped with fluorinated or partially fluorinated materials, for example PTFE.

### Catalyst Layer

The catalyst layer or catalyst layers contains or contain catalytically active substances. These include, amongst others, precious metals of the platinum group, i.e. Pt, Pd, Ir, Rh, Os, Ru, or also the precious metals Au and Ag. Furthermore, alloys of the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be employed.

The catalytically active particles comprising the above-mentioned substances may be used as metal powder, so-called black precious metal, in particular platinum and/or platinum alloys. Such particles generally have a size in the range of from 5 nm to 200 nm, preferably in the range of from 7 nm to 100 nm. So-called nanoparticles are also used.

Furthermore, the metals can also be used on a support material. Preferably, this support comprises carbon which may particularly be used in the form of carbon black, graphite or graphitised carbon black. Furthermore, electrically conductive metal oxides, such as for example, SnOₓ, TiOₓ, or phosphates, such as e.g. FePOₓ, NbPOₓm Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the bond of metal and support, is generally in the range of 1 to 80% by weight, preferably 5 to 60% by weight and particularly preferably 10 to 50% by weight; however, this should not constitute a limitation. The particle size of the support, in particular the size of the carbon particles, is preferably in the range of 20 to 1000 nm, in particular 30 to 100 nm. The size of the metal particles present thereon is preferably in the range of from 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Besides the catalysts or catalyst particles already commercially available, catalyst nano particles made of platinum-containing alloys, in particular based on Pt, Co and

Cu or Pt, Ni and Cu, respectively, can also be used in which the particles in the outer shell have a higher Pt content as in the core. Such particles were described by P. Strasser et al. in Angewandte Chemie 2007.

Furthermore, the catalytically active layer may contain customary additives. These include, amongst others, fluoropolymers, such as e.g. polytetrafluoroethylene (PTFE), proton-conducting ionomers and surface-active substances.

According to a particular embodiment of the present invention, the weight ratio of fluoropolymer to catalyst material comprising at least one noble metal and optionally one or more support materials is greater than 0.1, this ratio preferably lying within the range of 0.2 to 0.6.

According to a particular embodiment of the present invention, the catalyst layer has a thickness in the range of 1 to 1000 μm, in particular from 5 to 500, preferably from 10 to 300 μm. This value represents a mean value which can be determined by averaging the measurements of the layer thickness from photographs that can be obtained with a scanning electron microscope (SEM).

According to a particular embodiment of the present invention, the content of noble metals of the catalyst layer is 0.1 to 10.0 mg/cm², preferably 0.3 to 6.0 mg/cm² and particularly preferably 0.3 to 3.0 mg/cm². These values can be determined by elemental analysis of a flat sample.

The catalyst layer is in general not self-supporting but is usually applied to the gas diffusion layer and/or the membrane. In this connection, a part of the catalyst layer can, for example, diffuse into the gas diffusion layer and/or the membrane, resulting in the formation of transition layers. This can also lead to the catalyst layer being understood as part of the gas diffusion layer. The thickness of the catalyst layer results from measuring the thickness of the layer onto which the catalyst layer was applied, for example the gas diffusion layer or the membrane, the measurement providing the sum of the catalyst layer and the corresponding layer, for example the sum of the gas diffusion layer and the catalyst layer. The catalyst layers preferably feature gradients, i.e. the content of precious metals increases in the direction of the membrane while the content of hydrophobic materials is behaving contrarily.

For further information on membrane electrode assemblies, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned references with respect to the structure and production of membrane electrode assemblies as well as the electrodes, gas diffusion layers and catalysts to be chosen is also part of the description.

### Gaskets

To provide for better handling properties and to avoid leaks between the gas diffusion layer/electrode and the proton-conducting polymer electrolyte membrane or matrix, gaskets can be used.

These gaskets are preferably formed from meltable polymers which belong to the class of fluoropolymers, such as for example poly(tetrafluoroethylene-co-hexafluoropropylene) FEP, polyvinylidenefluoride PVDF, perfluoroalkoxy polymer PFA, poly(tetrafluoroethylene-co-perfluoro(methylvinylether)) MFA. These polymers are in many cases commercially available, for example under the trade names Hostafon®, Hyflon®, Teflon®, Dyneon® and Nowoflon®.

Furthermore, the gasket materials can also be made of polyphenylenes, phenol resins, phenoxy resins, polysulphide ether, polyphenylenesulphide, polyethersulphones, polyimines, polyetherimines, polyazoles, polybenzimidazoles, polybenzoxazoles, polybenzothiazoles, polybenzoxadiazoles, polybenzotriazoles, polyphosphazenes, polyether ketones, polyketones, polyether ether ketones, polyether ketone ketones, polyphenylene amides, polyphenylene oxides and mixtures of two or more of these polymers.

Apart from the materials mentioned above, gasket materials based on polyimides can also be used. The class of polymers based on polyimides also includes polymers also containing, besides imide groups, amide (polyamideimides), ester (polyesterimides) and ether groups (polyetherimides) as components of the backbone.

Preferred polyimides have recurring units of the formula (VI)

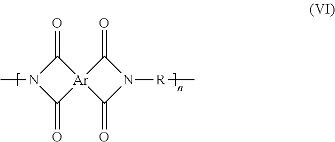

wherein the radical Ar has the meaning set forth above and the radical R represents an alkyl group or a bicovalent aromatic or heteroaromatic group with 1 to 40 carbon atoms. Preferably, the radical R represents a bicovalent aromatic or heteroaromatic group derived from benzene, naphthalene, biphenyl, diphenyl ether, diphenyl ketone, diphenylmethane, diphenyldimethylmethane, bisphenone, diphenylsulphone, quinoline, pyridine, bipyridine, anthracene, thiadiazole and phenanthrene, which optionally also can be substituted. The index n suggests that the recurring units represent parts of polymers.

Such polymers are commercially available under the trade names ®Kapton, ®Vespel, ®Toray and ®Pyralin from DuPont as well as ®Ultem from GE Plastics and ®Upilex from Ube Industries.

The thickness of the gaskets is preferably in the range of from 5 to 1000 μm, in particular 10 μm to 500 μm and particularly preferably 25 μm to 100 μm.

The gaskets can also be constructed with several layers. In this embodiment, different layers are connected with each other using suitable polymers, in particular fluoropolymers being well suited to establish an adequate connection. Suitable fluoropolymers are known to those in professional circles. These include, amongst others, polytetrafluoroethylene (PTFE) and poly(tetrafluoroethylene-co-hexafluoropropylene) (FEP). The layer made of fluoropolymers present on the gasket layers described above in general has a thickness of at least 0.5 μm, in particular at least 2.5 μm. This layer can be provided between the polymer electrolyte membrane and the polyimide layer. Furthermore, the layer can also be applied to the side facing away from the polymer electrolyte membrane. Additionally, both surfaces of the polyimide layer can be provided with a layer made of fluoropolymers. Through this, it is possible to improve the long-term stability of the MEAs.

Polyimide films provided with fluoropolymers which can be used according to the invention are commercially available under the trade name ®Kapton FN from DuPont.

The gasket and gasket materials described above may also be introduced between the gas diffusion layer and the bipolar plate such that at least one gasket frame is in contact with the electrically conductive separator or bipolar plates.

### Bipolar Plates

The bipolar plates or also separator plates are typically provided with flow field channels on the sides facing the gas diffusion layers to allow for the distribution of reactant fluids. The separator or bipolar plates are usually manufactured from graphite or conductive, thermally stable plastic. Furthermore, carbon composites, conductive ceramics or metallic materials are usually employed. This list only shows examples and is not limiting.

The thickness of the bipolar plates is preferably within the range of from 0.2 to 10 mm, in particular within the range of from 0.2 to 5 and particularly preferably within the range of from 0.2 to 3 mm. The specific resistance of the bipolar plates is typically lower than 1000 μOhm*m.

The production of a membrane electrode assembly according to the invention is apparent to the person skilled in the art. Generally, the different components of the membrane electrode assembly are superposed and connected with each other by pressure and temperature. In general, lamination is carried out at a temperature in the range of from 10 to 300° C., in particular 20° C. to 200° C. and with a pressure in the range of from 1 to 1000 bar, in particular 3 to 300 bar. In this connection, a precaution is usually taken which prevents damage to the membrane in the inner area. For this, a shim, i.e. a spacer, can be employed, for example.

According to a particular aspect of the present invention, the production of MEAs can preferably be performed continuously in this connection.

After cooling, the finished membrane electrode assembly (MEA) is operational and can—provided with bipolar plates—be used in a fuel cell.

To operate the fuel cell, the gaseous fuels are supplied—via the gas ducts present in the bipolar plates.

A hydrogen-containing gas is supplied on the anode side. The hydrogen-containing gas can be pure hydrogen or a gas containing hydrogen, in particular so-called reformates, i.e. gases which are produced from hydrocarbons in an upstream reforming step. The hydrogen-containing gas typically contains at least 20% by volume of hydrogen.

The supply of the hydrogen-containing gas on the anode side ideally takes place pressure-less with flow rates which are within the range of a stoichiometric excess which is at most double. However, it is also possible to operate the supply of the hydrogen-containing gas up to a positive pressure of 4 bar.

Insofar as proton-conducting polymer electrolyte membranes or a polymer electrolyte matrix which conducts protons based on the Grotthus mechanism are (is) employed, the fuel cell may also be operated at temperatures of more than 100° C. and in particular without humidification of the burner gas.

Higher operating temperatures, in particular of more than 120° C., allow for the use of pure platinum catalysts, i.e. without any further alloy components, displaying a high tolerance to carbon monoxide. In this way, the operation with reformates is possible. At temperatures of 160° C., e.g. more than 1% by volume of CO can be contained in the fuel without this leading to a markedly reduction in performance of the fuel cell.

Insofar as the proton-conducting polymer electrolyte membrane or polymer electrolyte matrix conducts protons based on the Grotthus mechanism, in particular, however, when using alkaline polymers, particularly preferably based on polyazoles containing acids or aciduous compounds, the hydrogen-containing gas can include up to 5% by volume of CO.

A gas mixture which includes at least oxygen or nitrogen is supplied on the cathode side. This gas mixtures acts as an oxidant. Besides non-naturally occurring, i.e. synthetic gas mixtures of oxygen and nitrogen, air is preferred as the gas mixture.

The supply of the gas mixture which includes at least oxygen and nitrogen on the cathode side ideally takes place pressure-less with flow rates which are within the range of a stoichiometric excess which is at most 5-fold.

However, it is also possible to operate the supply of the gas mixture which includes at least oxygen and nitrogen up to a positive pressure of 4 bar.

The controlled switch-off of the fuel cell in accordance with the method according to the invention is effected by discontinuing the gas supply on the cathode side. The gas supply on the cathode side is preferably shut off with regard to the environment. When the gas supply on the cathode side is discontinued, hydrogen-containing gas is still supplied on the anode side and a low current is drawn for a short time such that the oxygen present on the cathode side is consumed until the oxygen concentration on the cathode side of the fuel cell is reduced to a concentration of 5% by volume and less, preferably 3% by volume and less, in particular 1% by volume and less.

If the oxygen concentration on the cathode side of the fuel cell has been reduced to below 5% by volume and less, preferably 3% by volume and less, in particular 1% by volume and less, the fuel cell can be switched off and the supply of the hydrogen-containing gas on the anode side can be discontinued. The gas supply on the anode side is preferably shut off with regard to the environment. The nitrogen remaining on the cathode side may also be used for purging the anode side.

The fuel cell is subsequently cooled to room temperature and less without any problems. After starting it up again, it was surprisingly found that the fuel cell had suffered no or only a very small irreversible loss in performance. Thus, the service life of the fuel cell is significantly extended.

The fuel cells operated by means of the method according to the invention display a very high long-term stability, in particular in non-continuous operation.

### EXAMPLE 1

This example serves as a reference.

A 50 cm² fuel cell is operated at T=180° C. and p=1 barₐ. Synthetic reformate with a composition of 70% H₂, 2% CO and 28% CO₂ serves as the anode gas. Air serves as the cathode gas. The fuel cell consists of a membrane electrode assembly and flow field plates. The membrane electrode assembly consists of a composite of a membrane made of polybenzimidazole and phosphoric acid and two Pt catalyst-containing electrodes which were laminated onto the opposing sides of the membrane. Both electrodes also include gas diffusion layers. The membrane electrode assembly is operated in a fuel cell between two flow field plates, the gas distribution within the flow field plate taking place through milled ducts.

The fuel cell is operated with the following cycle:
6 h at 0.2 W/cm² at 180° C.
Cell operation is stopped, that means, the current is set to 0 A.
Gas supply is stopped, i.e. die anode and cathode flows are set to zero.
Cooling of the cell to ca. 60° C.
Reheating of the cell: Starting the gas supply from 120° C.
Reheating of the cell: Setting of load to 0.2 W/cm² from 160° C.
Cell operation for 6 h at 180° C. and 0.2 W/cm²

### EXAMPLE 2

This example describes an operation of a fuel cell according to the invention. A 50 cm² fuel cell is operated at T=180° C. and 1 barₐ. Synthetic reformate with a composition of 70% H₂, 2% CO and 28% CO₂ serves as the anode gas. Air serves as the cathode gas. The fuel cell consists of a membrane electrode assembly and flow field plates. A valve 1 is fixed in front of the gas inlet of the cathode. A valve 2 is fixed behind the gas outlet of the cathode. Both valves can be opened and closed as needed.

The membrane electrode assembly consists of a composite of a membrane made of polybenzimidazole and phosphoric acid and two Pt catalyst-containing electrodes which were laminated onto the opposing sides of the membrane. Both electrodes also include gas diffusion layers. The membrane electrode assembly is operated in a fuel cell between two flow field plates, the gas distribution within the flow field plate taking place through milled ducts. The gas volume between closed valve 1 and closed valve 2 is 12.1 NmL.

The fuel cell is operated with the following cycle:
6 h at 0.2 W/cm² at 180° C.
The cell current is set to 10 mA/cm², valve 1 and subsequently valve 2 are closed. The current of 10 mA/cm² is held for 85 s. Taking Faraday's Law into consideration, 99.4% of the cathode oxygen present is consumed.
The current is set to 0 and the anode gas flow is stopped.
Cooling of the cell to ca. 60° C.
Reheating of the cell: Starting the gas supply on the anode side from 120° C.
Opening of valve 2 and valve 1 at start of the air supply.
Reheating of the cell: Setting of load to 0.2 W/cm² from 160° C.
Cell operation for 6 h at 180° C. and 0.2 W/cm²

The figure shows a comparison of the cell voltage of cells 1 and 2 at 0.2 W/cm² as a function of the number of start/stop cycles. The degradation rates of the cells were determined from the incline of a linear regression slope through the data points. The degradation rate is thus given as the loss in voltage per start/stop cycle. The results of both examples are summarised in table 1. It can be clearly seen that cell 2 with an operation according to the invention by reducing the partial oxygen pressure on the cathode side to 0.6% by volume when switching off displays a degradation rate 3 times lower than reference cell 1.

TABLE 1

| | | Degradation rate [V/cycle] |
|---|---|---|
| | | (incline of the linear |
| Example | Description | regression slope) |
| Cell 1 | Reference | −0.9 |
| Cell 2 | Operation according to the | −0.3 |
| | invention (see example 2) | |

1-18. (canceled)

19. A method for operating a fuel cell comprising
(i) a proton-conducting polymer electrolyte membrane or polymer electrolyte matrix,
(ii) at least one catalyst layer which is arranged on both sides of the proton-conducting polymer electrolyte membrane or polymer electrolyte matrix,
(iii) at least one electrically conductive gas diffusion layer which is arranged on both averted sides of the catalyst layer,
(iv) at least one bipolar plate which is arranged on both averted sides of the gas diffusion layer,
comprising the following steps:
a) supplying a hydrogen-containing gas through the gas diffusion layer to the catalyst layer on the anode side by means of the gas ducts present in the bipolar plate,
b) supplying a gas mixture containing oxygen and nitrogen through the gas diffusion layer to the catalyst layer on the cathode side by means of the gas ducts present in the bipolar plate,
c) generating protons at the catalyst layer on the anode side,
d) diffusing the generated protons through the proton-conducting polymer electrolyte membrane or polymer electrolyte matrix,
e) reacting the protons with the oxygen-containing gas supplied from the cathode side,
f) tapping the formed voltage potential by means of the bipolar plate on the anode side and on the cathode side,
wherein, to switch off the fuel cell, the supply of the gas mixture which contains oxygen and nitrogen is discontinued and the oxygen present at the cathode is reacted to exhaustion by means of reaction with the protons present and the residual oxygen content at the cathode side of the fuel cell is reduced to a concentration of 5% by volume and less.

20. The method according to claim 19, wherein the proton-conducting polymer electrolyte membrane comprises materials in which the polymer includes at least one covalently bound acid or in which the polymer is doped with an acid.

21. The method according to claim 19, wherein the proton-conducting polymer electrolyte matrix comprises at least one alkaline polymer and at least one acid.

22. The method according to claim 19, wherein the proton-conducting polymer electrolyte matrix or polymer electrolyte matrix is a blend of at least two different polymers.

23. The method according to claim 19, wherein the fuel cell includes a proton-conducting polymer electrolyte membrane or proton-conducting polymer electrolyte matrix which comprises at least one alkaline polymer and at least one acid, and is operated at temperatures of more than 100° C. without additional humidification of the hydrogen-containing gas.

24. The method according to claim 23, wherein the fuel cell is operated at temperatures of more than 120° C.

25. The method according to claim 19, wherein the hydrogen-containing gas is pure hydrogen or a gas which includes at least 20% by volume of hydrogen.

26. The method according to claim 19, wherein the hydrogen-containing gas is a reformate which is produced from hydrocarbons during an upstream reforming step.

27. The method according to claim 19, wherein the supply of the hydrogen-containing gas takes place pressure-less and the flow rates are at most within a range of double the stoichiometric excess.

28. The method according to claim 23, wherein the hydrogen-containing gas includes up to 5% by volume of CO.

29. The method according to claim 19, wherein the gas mixture containing oxygen and nitrogen is a synthetic gas mixture of oxygen and nitrogen or air.

30. The method according to claim 19, wherein the supply of the gas mixture which includes at least oxygen and nitrogen on the cathode side takes place pressure-less and the flow rates are within the range of a stoichiometric excess which is at most 5-fold.

31. The method according to claim 19, wherein, to switch off the fuel cell, the supply of the gas mixture which contains oxygen and nitrogen is discontinued and the gas supply on the cathode side is shut off with regard to the environment.

32. The method according to claim 19, wherein, to switch off the fuel cell, the supply of the gas mixture which contains oxygen and nitrogen is discontinued and hydrogen-containing gas is still supplied on the anode side.

33. The method according to claim 19, wherein a current is drawn during the switch-off of the fuel cell until the fuel cell voltage decreases.

34. The method according to claim 32, wherein hydrogen-containing gas is supplied on the anode side until the residual oxygen content has reached the desired concentration.

35. The method according to claim 34, wherein the gas supply on the anode side is subsequently shut off with regard to the environment.

36. The method according to claim 35, wherein the nitrogen remaining on the cathode side is used for purging the anode side.

37. The method according to claim 19, wherein the residual oxygen content at the cathode side of the fuel cell is reduced to a concentration of 3% by volume and less.

38. The method according to claim 19, wherein the residual oxygen content at the cathode side of the fuel cell is reduced to a concentration of 1% by volume and less.
